(19) United States
(12) Patent Application Publication
(10) Pub. No.: US 2014/0172696 A1
(43) Pub. Date: Jun. 19, 2014

(54) METHOD AND SYSTEM FOR MANAGEMENT OF LOANS

(71) Applicant: Mauno HYVÄRINEN, Oulu (FI)

(72) Inventor: Mauno HYVÄRINEN, Oulu (FI)

(21) Appl. No.: 14/132,603

(22) Filed: Dec. 18, 2013

(30) Foreign Application Priority Data
Dec. 19, 2012 (FI) 20120417

(51) Int. Cl. G06Q 20/24

(52) U.S. Cl. CPC G06Q 20/24
USPC 705/39; 705/35

(57) ABSTRACT

A computerized information management system involving a client-server architecture. A memory comprises instructions for: storing information on each of several loans, wherein each loan is issued by a financial institution and received by a business actor, wherein the information on each loan comprises support provided to the financial institution and one or more obligations imposed on the financial institution, wherein the one or more obligations are imposed in exchange for the provided support; and retrieving some or all of the stored information in response to one or more requests from a client; and for using the retrieved information to check compliance with the imposed obligations. The obligations may include installment-free years of loans. As a result, businesses may retain more of the loan as operating capital, thus enhancing business activity, employment and tax payment.

### PARENT CASE INFORMATION

The present invention claims benefit from Finnish patent application 20120417, filed 19 Dec. 2012.

### FIELD OF THE INVENTION

The present invention relates to methods and systems for management of loans.

### BACKGROUND OF THE INVENTION

The global economic downturn, which started in 2008, has put businesses and the public sector in a very difficult financial situation. Financial institutions are suffering because of historically low interest rates. Despite negligible interest rates, businesses have trouble getting loans for lack of collateral security, and they are running out of operating capital. Lowering of interest rates has ceased to be a functional tool for boosting investment activity. Accordingly, there is a need for a novel financing scheme that alleviates at least some of these problems.

### SUMMARY OF THE INVENTION

It is an object of the present invention to alleviate one or more of the problems identified above. Specifically, it is an object of the present invention to provide methods and systems for a novel computer-managed financing scheme in which various actors on three tiers cooperate in a manner that supports employment and business activity without causing undue burden on financial institutions. In conventional loan systems, there are actors on two tiers, namely “businesses” that need loans and “financial institutions” that issue those loans. The traditional two-tier system no longer operates properly for the reasons described in the background section of this document, most notably the acute lack of collateral security. According to the present invention, the traditional two-tier model (“financial institutions” issuing loans and “business actors” receiving them) is augmented by a third layer which are called “catalysts” in the present document. The actors on the third layer include entities that, on one hand, can obtain loans and, on the other hand, have an interest in the smooth running of businesses. In a typical scenario, these entities include municipalities, states, government agencies or offices, international financial institutions, venture capitalists, business angels, or the like. In this document these entities are called “catalysts” because their role is comparable to a catalyst in a chemical reaction: compared with the net consumption of their own resources, the catalyst actors have a huge impact on the successful operation of businesses.

The role of the catalyst entities is as follows. Instead of directly supporting actors on the “business” tier, the catalyst actors support entities on the “financial institutions” tier. In an illustrative but non-restricting example, the invention can be used as follows. In addition to the normal interest that the business actor pays to the financial institution, the catalyst actor pays an extra interest subsidy on the installments of pre-existing or new loans (N.B. the catalyst actor does not pay interest subsidy on the whole loan sum, only on the deferred installments) over a predetermined period of time and according to a predetermined interest subsidy percent. In exchange of the provided support, the catalyst actor imposes an obligation on the financial institution to defer the installments of the business actor to begin after a predetermined period of time. As a result, the deferred installments of pre-existing loans add to the operating capital of the business actor and the deferment of installments of new loans extends sufficiency of the operating capital. Solvency of the financial institution increases because it does not have to pay back the interest subsidy paid by the catalyst actor.

In exchange of the provided support, the catalyst actors impose obligations on the financial institutions receiving support, wherein those obligations are of a nature that augments business activity, employment or the like. Because augmentation of business activity and employment results in more taxes and/or less unemployment benefits, the entities on the catalyst tier are likely to gain more than they invested in supporting the financial institutions. In a typical but non-restricting example, the obligations imposed on the financial institutions may include an obligation to issue loans with a number of installment-free years, such as two to ten, preferably three to seven and optimally about five years before loan installment begins.

Similarly, in exchange of the support from the catalyst entity to the financial institution, which indirectly supports the business in the form of installment-free years, for example, the catalyst entity may impose obligations on the business that obtains the loan. In a typical but non-restricting example, the obligations imposed on the business obtaining the loan may include various reporting duties. For example, the reporting duties may include duties to report on activities affected by the support. For instance, the business may be obliged to report an estimated amount of increased employment in the business. The various reports obtained from the businesses helps the catalyst entity to plan the support functionality in a manner that optimizes a set of criteria, which may include tax revenue, reduction in direct and indirect expenses due to unemployment, or the like.

Because the invention involves a multitude of actors on various tiers (in various roles), the invention is best implemented as a computer-controlled method and system for managing the various transactions among the various actors.

### BRIEF DESCRIPTION OF THE DRAWINGS

In the following section, specific embodiments of the invention will be described in greater detail in connection with illustrative but non-restrictive examples. A reference is made to the following drawings:

FIG. 1 shows a schematic model of the operating principle of the invention; and

FIG. 2 shows a computer architecture specially adapted for management of the various transactions among the participating entities.

### DETAILED DESCRIPTION OF SOME SPECIFIC EMBODIMENTS

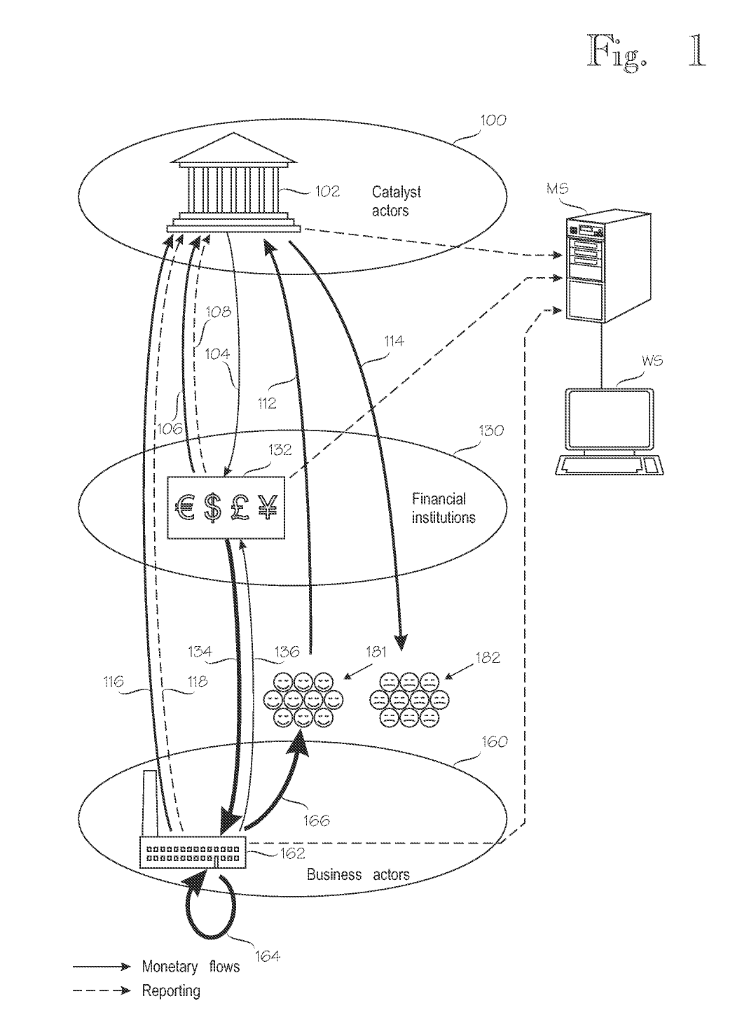

FIG. 1 shows a schematic model of the operating principle of the invention.

Reference number 100 denotes a first tier of actors. Actors on the first tier, one of which is denoted by reference number 102, have a role as catalyst actor. In a typical scenario, the catalyst actor 102 is a state or municipality. Reference number 130 denotes a second tier whose occupants have a role as financial institutions. Reference number 132 denotes an exemplary financial institutions, such as a bank. Reference number 160 denotes a third tier which is occupied by business actors, one of which is denoted by reference number 162. Solid arrows represent monetary flows, while dashed arrows represent information, such as reporting.

In an illustrative but non-restricting example, the invention can be used as follows. In addition to the normal interest 136 that the business actor 162 pays to the financial institution 132, the catalyst actor 102 pays an extra interest subsidy 104 on the installments of pre-existing or new loans (N.B. the catalyst actor does not pay interest subsidy on the whole loan sum, only on the deferred installments) over a predetermined period of time and according to a predetermined interest subsidy percent. In exchange of the provided support, the catalyst actor imposes an obligation on the financial institution 132 to defer the installments of the business actor 162 to begin after a predetermined period of time. As a result, the deferred installments of pre-existing loans add to the operating capital 164 of the business actor 162 and the deferment of installments of new loans extends sufficiency of the operating capital. Solvency of the financial institution 132 increases because it does not have to pay back the interest subsidy 104 paid by the catalyst actor 102.

In a conventional business model, the business actor 162 obtains a loan from the bank 132. The loan is indicated by reference number 134 and the interest by reference number 136. A portion of the business actor's incoming cash remains in the business actor as operating capital 164. The business actor 162 uses some of the incoming cash to pay salary 166 to its employees 181. The employees 181 pay taxes 112 to the state and/or municipality. The state or municipality pays various benefits to unemployed people 182. It is typical of the conventional business model that as soon as the business actor 162 obtains a loan, the business actor must use some of its operating capital 164 to loan installments. This begins to reduce the operating capital 164 almost immediately as soon as the business actor obtains the loan 134, and the portion used as loan installment does not have the time to generate revenue and employment in the business actor.

According to the invention, the catalyst actor 102, such as the state, municipality or international financial institution, provides a support for the financial institution 132, such as a bank, in cases where the financial institution 132 finances operation of the business actor 162. This support from the catalyst actor 102 to the financial institution (“bank”) 132 is denoted by reference number 104.

In exchange for the support 104, the catalyst actor 102 imposes certain obligations to the bank 132 and, optionally, to the business actor 162 that obtains the loan 134 from the bank 132. For instance, the obligations may include a number of installment-free years for the loan 134. The obligations imposed on the bank 132, such as the installment-free years, benefit the society in the following ways. The business actor 162 does not have to pay back the loan 134 immediately and can keep a bigger portion of incoming cash as operating capital 164. A benefit of the increased operating capital 164 is that the business actor 162 can employ more people 181 and/or reduce the number of people 182 that it would normally lay off. Compared with the traditional business model, the business actor 162 can pay more taxes 116 to the state or municipality, which are examples of the catalyst actor 102. The business actor 162 can also employ more people 181 who, in turn, pay more taxes 112 to the catalyst actor 102. Yet further, because the number of unemployed people 182 is reduced, the amount of unemployment benefits and health-related expenses 114 paid by the catalyst actor 102 are reduced.

All the various interactions result in a multifold leverage. What this means is that for a relatively modest support 104 to a financial institution (“bank”) 132, the catalyst actor 102 can collect increased taxes 116 from the business actor 162, increased taxes 112 from the employees 181 of the business actor 162, and increased taxes 106 from the bank 132.

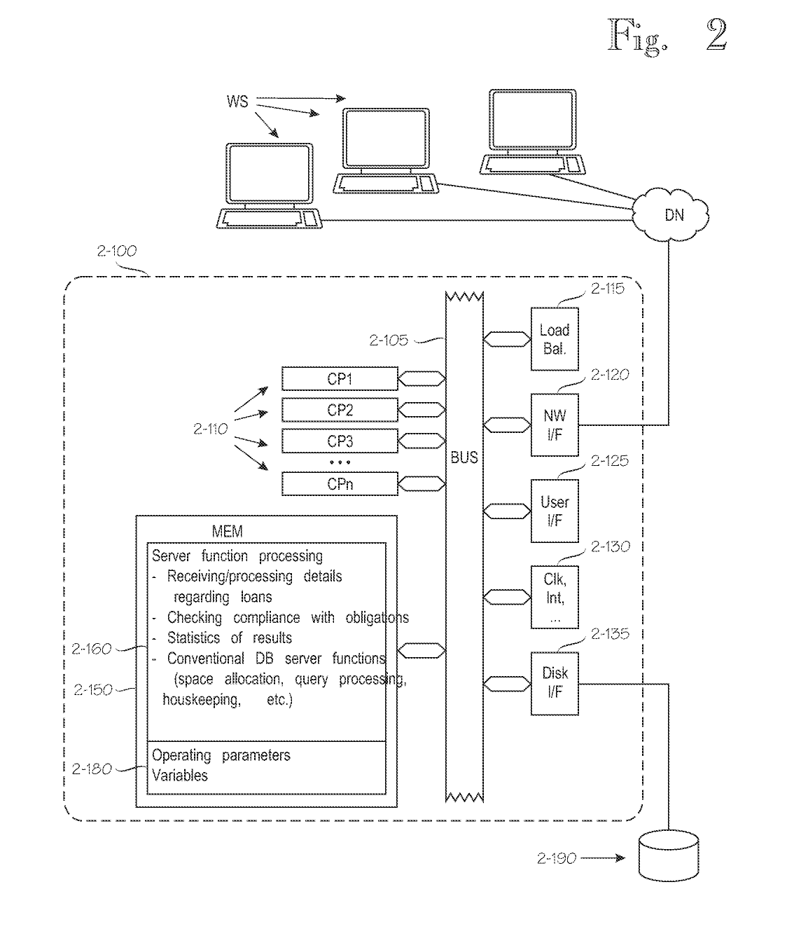

The ability of the catalyst actor 102 to benefit from the support 104, for example in the form of increased taxes 106, 112, 116, can be enhanced if the catalyst actor 102 imposes certain obligations on the business actor 162. Such obligations may include reporting. Reference numbers 108 and 118 denote reporting from the bank 132 and business actor 162, respectively. Enhanced reporting may be used to prevent hiding of income in tax havens and/or to promote lending of money to business actors or sectors that can use the money to create more jobs. To keep the operating principle shown in FIG. 1 reasonably clear, only one catalyst actor, one bank and one business actor are shown. Skilled readers will realize that large numbers of actors in each role will be involved. Because of the sheer number of actors and interactions among them, a computer-implemented management system is desired. Accordingly, FIG. 1 schematically shows a management server MS and a representative workstation WS, details of which will be described in connection with FIG. 2.

FIG. 2 schematically shows an exemplary block diagram for the management server MS shown in FIG. 1. FIG. 2 schematically shows a block diagram of a management server MS. The two major functional blocks of the management server MS are a management server computer 2-100 and a disk system 2-190. The server computer 2-100 comprises one or more central processing units CP1 . . . CPn, generally denoted by reference numeral 2-110. Embodiments comprising multiple processing units 2-110 are preferably provided with a load balancing unit 2-115 that balances processing load among the multiple processing units 2-110. The multiple processing units 2-110 may be implemented as separate processor components or as physical processor cores or virtual processors within a single component case. The server computer 2-100 further comprises a network interface 2-120 for communicating with various data networks, which are generally denoted by reference sign DN. The data networks DN may include local-area networks, such as an Ethernet network, and/or wide-area networks, such as the internet. The server system SS serves one or more management work stations PA-WS, via the data networks DN.

The server computer 2-100 of the present embodiment also comprises a user interface 2-125. Depending on implementation, the user interface 2-125 may comprise local input-output circuitry for a local user interface, such as a keyboard, mouse and display (not shown). Alternatively or additionally, management of the server computer 2-100 may be implemented remotely, by utilizing the network interface 2-120 and a terminal similar to the management workstations WS. The nature of the user interface depends on which kind of computer is used to implement the server computer 2-100. If the server computer 2-100 is a dedicated computer, it may not need a local user interface, and the server computer 2-100 may be managed remotely, such as from a web browser over the internet, for example. Such remote management may be accomplished via the same network interface 2-120 that the server computer utilizes for traffic between itself and the client terminals.

The server computer 2-100 also comprises memory 2-150 for storing program instructions, operating parameters and variables. Reference numeral 2-160 denotes a program suite for the server computer 2-100.

The server computer 2-100 also comprises circuitry for various clocks, interrupts and the like, and these are generally depicted by reference numeral 2-130. The server computer 2-100 further comprises a disk interface to the disk system 2-190. The various elements 2-110 through 2-150 intercommunicate via a bus 2-105, which carries address signals, data signals and control signals, as is well known to those skilled in the art.

The inventive method may be implemented in the server system SS as follows. The program suite 2-160 comprises program code instructions for instructing the set of processors 2-110 to execute the functions of the inventive method, wherein the functions include performing the management functions according to the invention and/or its embodiments. Specifically, the functions of the inventive method include the acts defined in claim 1.

In addition to the acts defined in claim 1, specific embodiments of the management server, or the client-server architecture, may implement additional functionality. For instance, the management server may receive from a workstation and store in the disk system one or more of the following features:
information on financial institutions and loan recipients (business actors) that are within the method of the present invention or its embodiments;
annual or periodical installments of each loan and/or loan recipient;
interest rate;
total amount of loans;
installment schedule in periods, such as years;
installment-free period of loans, such as number of years;
support provided to the financial institutions (eg banks) such as interest subsidy (eg partial, full or excess payment of interest rate of the loan) in exchange for the installment-free period;
financial statements, numbers of employees and/or total salaries paid of the loan recipients (business actors) before and after entry to the method of the present invention.

Information on the loans are ideally reported by the issuer and recipient of each loan, whereby the management server system can compare the information received from the parties and check compliance with the obligations.

The management server or the client-server architecture, may compute various statistics, such as:
amount and duration of support, such as interest subsidy, received by each financial institution, wherein the amount may be indicated in currency units, percentage points or both;
business actors having obtained installment-free periods to their loans, and the duration and/or monetary value of the installment-free periods;
leverage obtained from the support, such as interest subsidy; the leverage may be computed by totaling the operating capital increase in the business actors and dividing the operating capital increase by the total interest subsidy.

Those skilled in the art will realize that the inventive principle may be modified in various ways without departing from the spirit and scope of the present invention.

1. A method comprising:
performing following acts on an information management system which involves a client-server architecture:
in a server portion of the client-server architecture:
storing information on each of several loans, wherein each loan is issued by a financial institution and received by a business actor, wherein the information on each loan comprises support provided to the financial institution and one or more obligations imposed on the financial institution, wherein the one or more obligations are imposed in exchange for the provided support;
retrieving some or all of the stored information in response to one or more requests from a client portion of the client-server architecture;
and in the information management system:
using the retrieved information to check compliance with the imposed obligations.

2. The method according to claim 1, wherein the provided support includes a partial, full or excess payment of an interest rate of the loan.

3. The method according to claim 1, wherein the one or more obligations imposed on the financial institution comprise an obligation to issue the loan with deferred loan installments, wherein the loan installments are deferred over a period that exceeds one year.

4. The method according to claim 3, wherein the period exceeds three years.

5. The method according to claim 3, wherein the support provided to the financial institution comprises a partial, full or excess payment of an interest rate for the deferred loan installments.

6. A computer-implemented information management system comprising a server for supporting one or more clients, the server comprising:
at least one processing unit;
memory for storing applications and data;
wherein the memory comprises program code instructions for instructing the at least one processing unit to carry out the following acts:
in the server:
storing information on each of several loans, wherein each loan is issued by a financial institution and received by a business actor, wherein the information on each loan comprises support provided to the financial institution and one or more obligations imposed on the financial institution, wherein the one or more obligations are imposed in exchange for the provided support;
retrieving some or all of the stored information in response to one or more requests from a client;
and in the information management system:
using the retrieved information to check compliance with the imposed obligations.

7. The computer-implemented information management system according to claim 6, wherein the one or more obligations imposed on the financial institution comprise an obligation to issue the loan with deferred loan installments, wherein the loan installments are deferred over a period that exceeds one year.

8. The computer-implemented information management system according to claim 7, wherein the support provided to the financial institution comprises a partial, full or excess payment of an interest rate for the deferred loan installments.
